(19) United States
(12) Patent Application Publication
(10) Pub. No.: US 2010/0146401 A1
(43) Pub. Date: Jun. 10, 2010

(54) Webtop and monetization engine, system and method

(76) Inventor: Robb Fubioka, Manhattan Beach, CA (US)

Correspondence Address: Thomas J. McWilliams, Esquire;Drinker Biddle & Reath LLP, One Logan Square, 18th & Cherry Streets, Philadelphia, PA, 19103-6996, US

(21) Appl. No.: 12/592,508

(22) Filed: Nov. 25, 2009

Related U.S. Application Data
(63) Continuation-in-part of application No. 12/383,456, filed on Mar. 24, 2009.
(60) Provisional application No. 61/070,611, filed on Mar. 24, 2008.

(51) Int. Cl. G06F 3/01

(52) U.S. Cl. 715/747

(57) ABSTRACT

Systems and methods for the an improved webtop, and a monetization engine that better takes advantage of the interests and life segments of a user are described. A monetization engine embedded in a hyperspace webtop, is provided which comprises a user record comprising a plurality of information items regarding life segments of at least one user, a presentation engine that presents advertisements to at least the user in accordance with at least one information item, and a plurality of tabs, wherein at least one of the tabs is presented to the user in accordance with at least one information item, and wherein each of the plurality of tabs is indicative of content associated with a third party having available for sale to at least one user at least one selected from the group consisting of a good and a service.

### CROSS-REFERENCE TO RELATED APPLICATIONS

This application is a continuation-in-part of U.S. Application Ser. No. 12/383,456, entitled “WEBTOP AND MONETIZATION ENGINE, SYSTEM AND METHOD”, filed Mar. 24, 2009, the entire disclosure of which is hereby incorporated by reference as being set forth in its entirety herein.

### FIELD OF THE INVENTION

The present invention relates to internet use, and, more specifically, to a webtop and monetization engine, system and method.

### DESCRIPTION OF THE BACKGROUND

In a typical computer-use in the present art, a user, upon each usage of a computer, must sit for a lengthy session of logging into a laundry list of websites, e-mail accounts, and computing communities or social networks. Alternatively, a user may use multiple browser, browser tabs, or favorite site marking to maintain the often lengthy list of internet locations frequented. Thus, the current art offers no personalized, organized and convenient digital experience. Further, even were the available art to offer such an improved, personalized experience, the experience would not be relevant to the different aspects, or segments, of a typical user's life, such as Work, Family, Entertainment, Community, etc. Additionally, this lack of understanding of the segments, and important elements, of a typical user's life, as well as a lack of involvement in the web-surfing process, limits the marketing and sales opportunities available in the present art.

Thus, the need exists for an improved webtop, and a monetization engine, system and method that better takes advantage of the interests and life segments of a user.

### SUMMARY OF THE INVENTION

The present invention is directed to a monetization engine embedded in a hyperspace webtop, including a user record comprising a plurality of information items regarding life segments of at least one user, a presentation engine that presents advertisements to at least the user in accordance with at least one information item, and a plurality of tabs, wherein at least one of the tabs is presented to the user in accordance with at least one information item, and wherein each of the plurality of tabs is indicative of content associated with a third party having available for sale to at least one user at least one selected from the group consisting of a good and a service.

The present invention solves problems experienced with the prior art because it provides for an improved webtop, and a monetization engine, system and method that better takes advantage of the interests and life segments of a user. Those and other advantages and benefits of the present invention will become apparent from the detailed description of the invention hereinbelow.

### BRIEF DESCRIPTION OF THE DRAWINGS

Understanding of the present invention will be facilitated by consideration of the following detailed description of the embodiments of the present invention taken in conjunction with the accompanying drawings, in which like numerals refer to like parts and in which:

FIG. 1a is a illustrative representation of the monetization engine according to an aspect of the present invention;

FIG. 1b is a illustrative representation of the monetization engine according to an aspect of the present invention;

FIG. 1c is a illustrative representation of the monetization engine according to an aspect of the present invention;

FIG. 2 is a illustrative representation of the monetization engine according to an aspect of the present invention;

FIG. 3 is a illustrative representation of the monetization engine according to an aspect of the present invention;

FIG. 4 is a illustrative representation of the monetization engine according to an aspect of the present invention;

FIG. 5 is a illustrative representation of the monetization engine according to an aspect of the present invention; and

FIG. 6 is a illustrative representation of an aspect of the present invention.

### DESCRIPTION OF THE INVENTION

It is to be understood that the figures and descriptions of the present invention have been simplified to illustrate elements that are relevant for a clear understanding of the present invention, while eliminating, for the purposes of clarity, many other elements found in typical computing apparatuses, systems and methods. Those of ordinary skill in the art will recognize that other elements are desirable and/or required in order to implement the present invention. However, because such elements are well known in the art, and because they do not facilitate a better understanding of the present invention, a discussion of such elements is not provided herein.

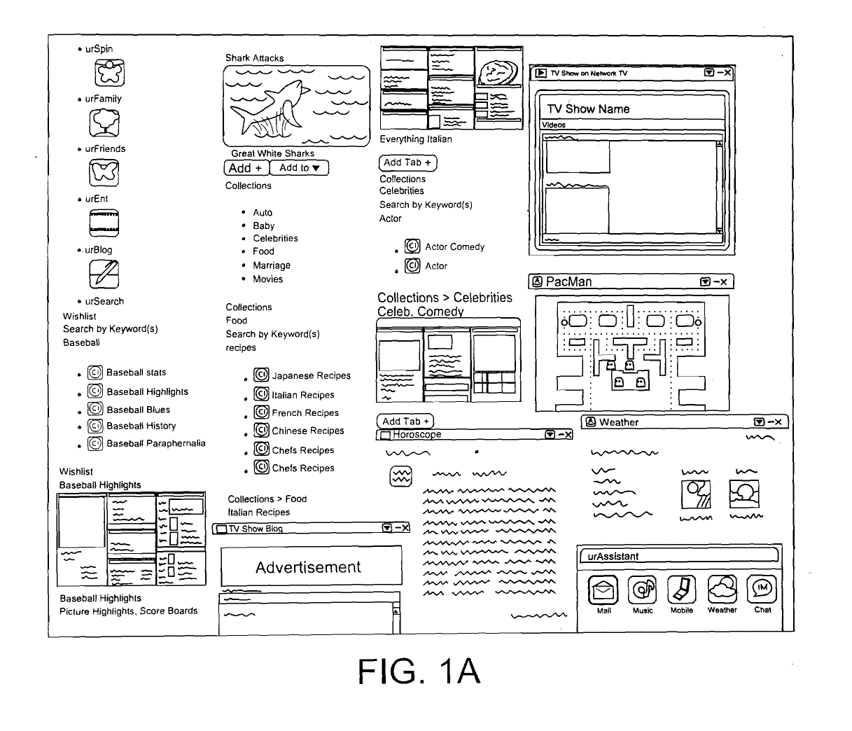

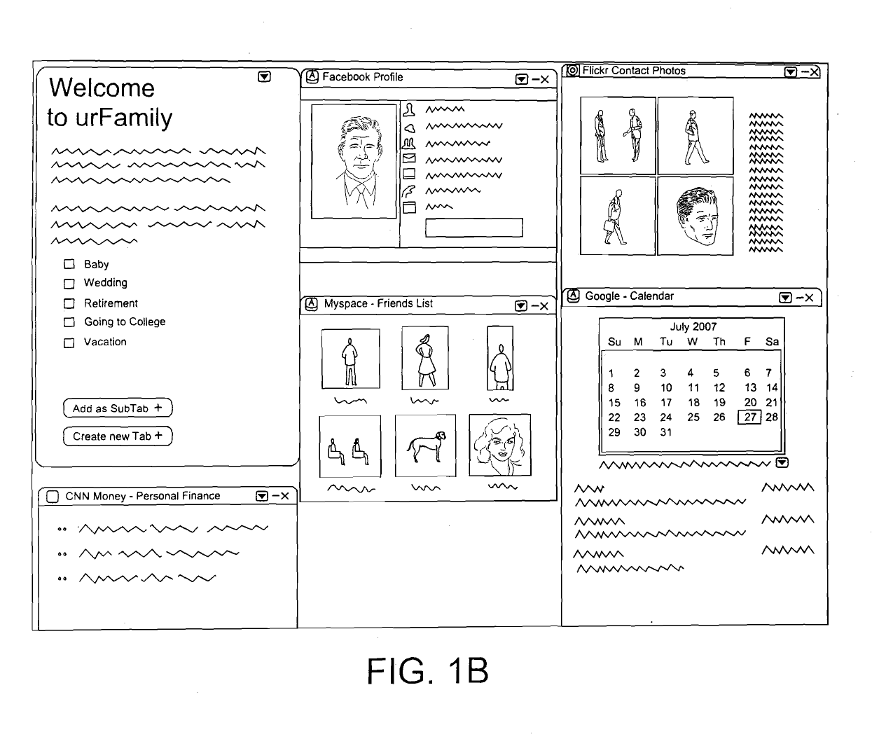

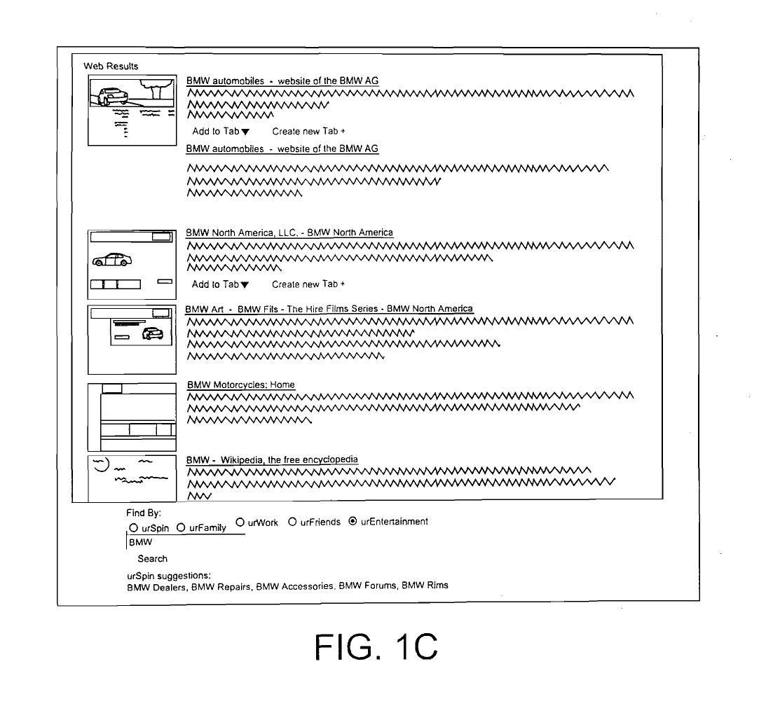

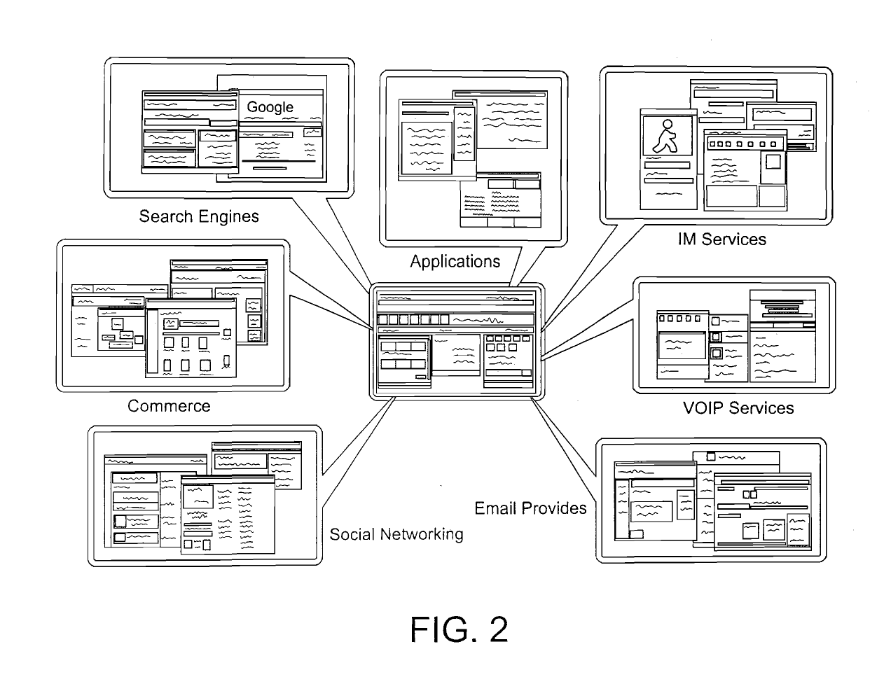

The present invention may include a personalized webtop, such as that shown in FIG. 1a-c. The personal webtop of the present invention may function and behave much like a traditional Personal Computer (“PC”) desktop. However, although the webtop can run entirely inside a traditional web browser, its functionality is not limited to a single device or platform. For example, the webtop may offer drag-and-drop content functionality, web-based centralized storage, and collaboration tools, and thereby the webtop may become the centralized storage and access point for all content and web applications a user desires. It may utilize a core structure based on any of a variety of factors, such as life-segment, and may present dynamic data triggered by key events correspondent to the core structure, such as key life events (e.g., having a baby, going to college). By dividing the webtop into segments around a core structure (work, family, entertainment, and community, for example), a better understanding of the users is made available, thereby allowing for development of strategic marketing and monetization channels, as well as presently unavailable partnerships, all to the benefit of the user and the marketer. For example, as depicted in FIG. 2, the user may access favorite web properties, including multiple sites, IM services, VOIP services, email accounts, and social networking sites, to name a few. Needless to say, each such web property may create a monetizable avenue. Further, it almost goes without saying that, due to the nature of the aforementioned webtop, and its capability for use in an application space within a hyper-visor, for example, the monetization events discussed herein throughout, including those based on ad serving, may be performed within a hyperspace.

For example, either through the aforementioned webtop, or via a prior art desktop or webtop, users may be provided the capability to create their own content rich widgets, which may be, in whole or in part, sponsored by advertisers. These widgets may, for example, have click through capability to purchase the sponsored product (e.g., click to Amazon or iTunes, for example). Further, the present invention may allow for a search engine to locate such widgets, or preferred portions of a widget for placement into an overall widget, and such searching may be monetized for these widgets in the manner in which presently available “web crawling” search engines, such as Google or Yahoo!, are monetized.

A widget in accordance with the present invention, and as will be understood by one of ordinary skill in the art, is a portable portion of code that may be installed or executed within any separate HTML based webpage by an end user without necessitating additional compilation of that code portion. Such widget code portions, in accordance with the present invention, are embeddable by the end user. As such, a widget in accordance with the present invention is any code portion that may be embedded by the end user within a selected page of HTML, XML, or like code that causes presentation of that selected web page. The widget, via the embedded code portion, thereby adds non-static content to the subject webpage.

Widgets may also take the form of small, stand-alone application modules for incorporation into an existing platform to provide discrete programs. Such widgets may allow for easy connectivity to remote content, may allow for the display or gathering of remote content, and/or may provide a functional tool. For example, a widget may be embeddable on an existing dashboard and may provide for the display of the local weather. The same widget may also provide access to a remote content, such as a web page for more detailed local weather conditions and/or the ability to search geographies, for example. Similarly, a widget may also provide secure and/or preferred access to a shopping site—allowing for personalized access to the third party content without having to manually log-in or require the user to always identify themselves.

A widget in accordance with the present invention may allow a user to take a discreet portion of a favored user experience on a network, such as a portion of favorite interactive information, a favorite website, or a particular application, and transport that favorite portion for use in an approved on-line experience targeted to the particular interests of that user. For example, such a widget constituting a discreet portion of a favored user experience may be applied to the aforementioned web top experience to personalize such a desktop or web top experience to that particular user. Further, such widgets in the present invention may allow for transport of a favored user experience to other user experience locations, such as computing communities and/or social networking sites, in order to improve that user's experience of such other sites or network locations. Needless to say, as used herein a network or network experience is and includes an internet, intranet, extranet, telecommunications network, and any other network experience that allows for importation of the widget concept. Thus, via the creation of an improved user experience on a webtop or desktop, and/or via allowing for the transport of a favored user experience, the user may be charged an appropriate fee, thereby allowing for a monetization event.

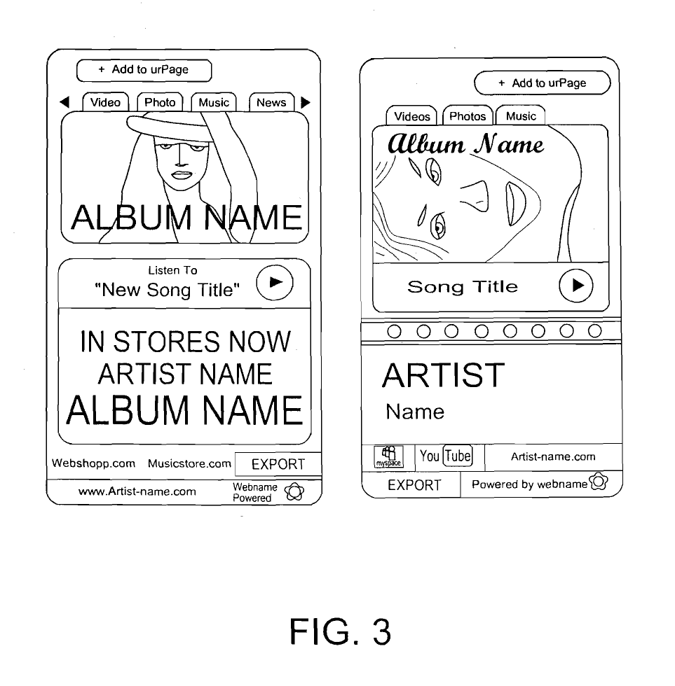

In an exemplary embodiment of the present invention, the widgets may be located by a user, or designed by a user, in accordance with preferred techniques. Such preferred techniques may include, for example, in the case of the user-defined widget, the provision of widget templates, into which a user may develop that user's own unique widgets by using discreet physical locations within such template to place code for the subject widget in an overall widget physical format provided by the template. For example, such a widget template may be divided into fields, wherein a user may be given discreet options for each portion of the field as to what widget content the user wishes the ultimate widget to have in that field. For example, the user may click on a particular field, such as the upper left quadrant of the subject widget as illustrated in FIG. 3, and may be presented with a series of content links that are authorized for incorporation into the widget, or a dropdown menu from which the user can select authorized types of content for that portion of the widget, or a hierarchal dropdown menu from which the user can select a top level, and subsequently more specific levels of allowed content from the available authorized content. The user may thereby be charged for the placement of such content into a widget field.

Further, the use of particular content in one portion of a widget template may limit the allowable content in other portions of the widget template. For example, once a user elects to have a quadrant of a widget themed in accordance with a particular musical artist, the template may limit the allowable artists that may be involved in other portions or quadrants of the widget template. Marketed entities or marketers may pay a fee for this “exclusivity” service. For example, in the event that an active aspect for the overall widget is incorporated into the upper left quadrant of FIG. 3 in relation specifically to musical artist Eminem, and thereby at least a portion of the widget code relates to artist Eminem, the options available for the remainder of the widget may be limited only to those relating to musical artist Eminem, that is, for musical widget content, all of the code for the overall widget must relate to the artist Eminem, or may be limited to only those artists recording on the same label as Eminem. Upon design of a widget, the user may “publish” the widget to a desired location.

Additionally, a library of existing widgets may be designed to be made available to improve the user experience upon use of a particular web top or desktop. Such a library may be available via a particular website, via a web top application, via a desktop application, or via discreet application, for example. For example, under the assumption that rights are obtained to create widgets for placement into the library with regard to all artists operating under a particular music recording label, widgets may be designed for placement into the library for all artists recording under that music label. Searching this library presents an availability of a particular search fee, if desired, and creates advertising opportunities akin to those employed by prior art search engines.

Similarly, the present invention include a fully portable, widgetized avatar having associated therewith multiple items of information and/or social information that may be generally searched for and/or otherwise requested for association with at least two different computing communities or transactions. Widgetization of the avatar of the present invention necessarily allows for portability of the avatar of the present invention. Needless to say, a monetization event may occur to allow for the generation of a fully transportable, widgetized avatar.

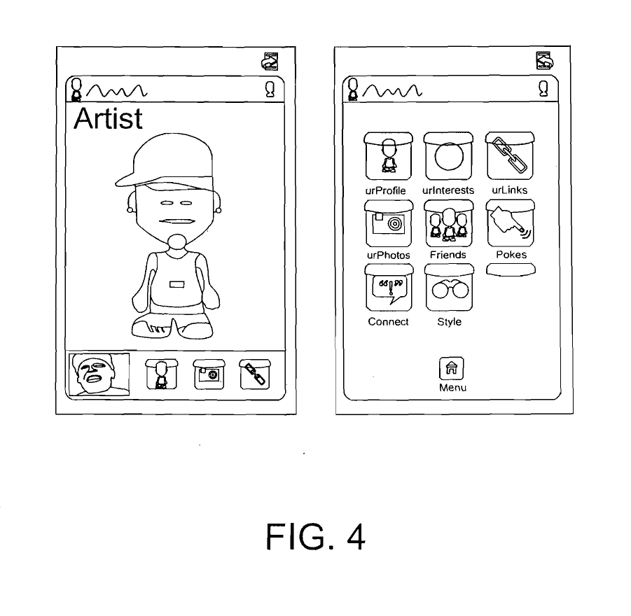

The present invention may provide a physical manifestation of all of this information, such as in a “trading card” format widget, as illustrated in FIG. 4. For example, the front of the virtual trading card may include an avatar having particular physical features, clothing, accessories, activities, likes, dislikes and expertise, and the like, along with an associated user name. However, when an interaction, such as selection of a drop-down menu, selection of a link, a double click, or the like is undertaken to “flip” a trading card to the back, a myriad of additional information is displayed regarding the user related to the widgetized avatar, such as age, interests, likes and dislikes, employment status, and the like.

The physical manifestation of a widgetized avatar in accordance with the present invention allows for the monetization of the selection, by the user, of certain clothing or accessories for his or her avatar. For example, a user may pay a fee to access and use certain virtualized clothing and accessories based on the lines of real-world clothing and accessory providers (e.g. Phat Farm, Gucci). Conversely, selection by a user of a virtualized clothing or accessories, such as for the aforementioned fee, may present a high probability upsell of real-world goods to that user. For example, if a user purchases a Gucci purse for her avatar, the probability is higher that the user will want to purchase a real-world Gucci purse for herself. Thus, targeted advertising may be directed to the subject user, or a direct real-world purchase opportunity presented to the user, based on the purchase of virtualized goods. Needless to say, in an alternative embodiment, the reverse case may likewise be true, that is, the purchase of a real-world good may lead to an endeavor to sell a virtualized good. Thus, not only may the sale to the user of virtualized and/or real-world goods be monetized, but likewise the sale of highly targeted advertising, based on clearly and simultaneously known preferences, may also be monetized.

Through the use of the present invention, widgets may be tracked. For example, widgets of the present invention may be associated with a cached identification, which is matched to the widget, and as such each time the widget is dragged and dropped downloaded, or otherwise moved and/or used in a user's desired location, such as a web top, the movement and/or download of the widget is tracked. As such, information with regard to the party's dragging and dropping the widget, or the point to point locations from which a widget is dragged and dropped each time that widget is dragged and dropped, may be tracked by tracking of the associated cached identification. As such, particular metrics, such as Google® metrics, may be associated with each widget, and the use of each widget. Such tracking information may be provided, such as to the publisher, i.e., the third party creator, of a particular widget, in order that the publisher may be enabled to make an accounting for the use and/or download of the widget. Thereby, payment methodologies may be associated with the use and/or download of the widget, and monetization opportunities present based on the tracking information associated with each widget.

Additionally, for example, as will be understood by those skilled in the art in light of the discussion herein, in embodiments wherein the certain characteristics of a user are known to the search engine of the present invention, the downloading of widgets in accordance with the present invention allows for a monitoring of who performed a search, what they deemed most relevant responsive to it, and what was done responsive to that relevance, such as the downloading of a widget. Thus, again, the present invention may provide an advanced marketing and sales tool.

Further, discretely or in association with the aforementioned tracking of widgets, the use of particular widgets may allow for assumptions with regard to the interest of the downloading user of the subject widget. Thereby, monetization, such as advertising monetization, may be associated with the user of the subject widget, such as by allowing for the presentation to the user of particular advertisements, such as from an advertising server, based on the user's use or download of a particular widget. Further, such advertising may be directly associated by the publisher of the subject widget for presentation to the user of the subject widget at predetermined times, or upon predetermined uses of the subject widget. For example, a publisher, i.e., a third party creator, of a subject widget may determine that an advertisement related to that publisher is to be displayed to a user at least once per week following the downloading by that user of a widget associated with that publisher.

Additionally, the webtop discussed herein throughout may include multiple search options, such as those discussed herein throughout and/or multiple search engines, or may present different search options based on any number of factors, such as user characteristics, such as age or income, user preferences, and/or user geographic location. Thereby, monetization from search engine providers may be provided by allowing for the use of different search engines on different devices employing the referenced webtop, i.e. search engine 1 on cell phones and search engine 2 on the internet, and/or the use of different search engines by users in different geographic locations.

Further, the present invention may allow for the presentation of original content, and/or the licensing of third party content and/or content presentation methodologies. Thereby, the present invention allows for a monetization event in capitalizing on advertising revenue when such original and/or licensed content is viewed, such as by a user of the aforementioned webtop.

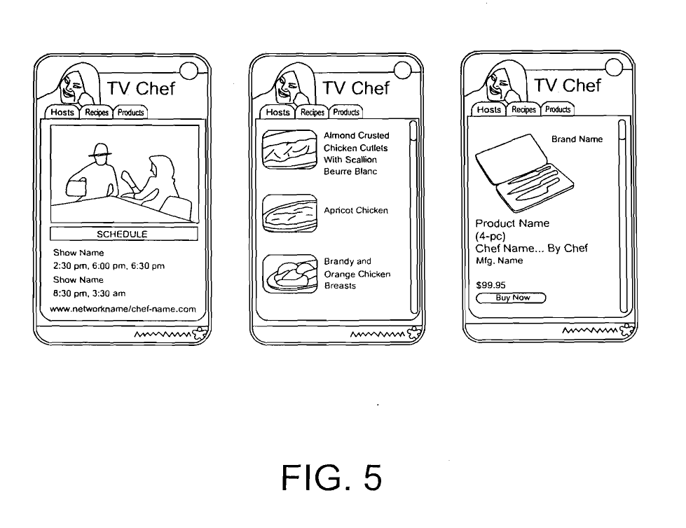

Additionally, the present invention may generate revenue by selling “Tabs” on the referenced webtop, as illustrated in FIG. 5, to content providers who want to create their own sub-experience within the webtop. For example, Johnson & Johnson may wish to sponsor the “baby care” tab on the main “cover page” of the subject webtop. Because the webtop of the present invention may operate in an application space of a hyperspace, and thus may be embedded in the device as always being presented to the user as an unchangeable “cover page”, such “cover page tabs” may provide a very highly desirable advertising location. To capitalize on this and to provide a compelling user experience, tabs may be provided to a company willing to pay for a tab and maintain a compelling user experience within its respective tab. Of course, as was the case with search methods, tabs may be geographically localized or monetized.

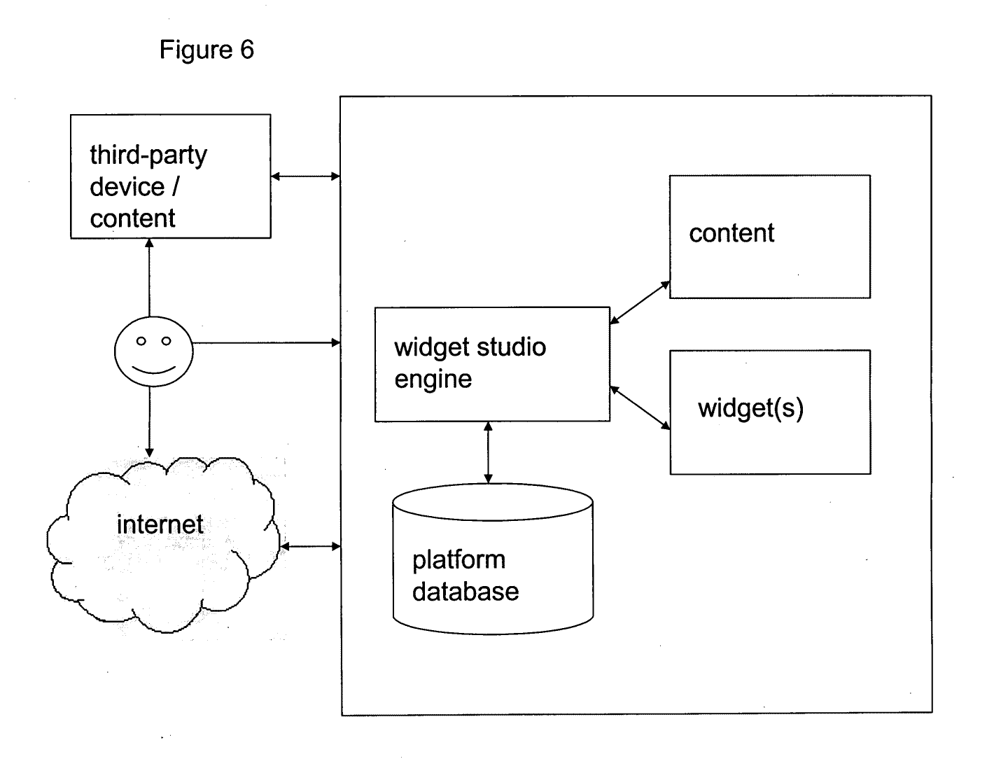

A widget in accordance with the present invention may also be created by a user for distribution to allow for the sharing of the network and/or network experience. Such widgets may be tailored for operation in a web, social-networking, desktop, and/or mobile environment. The created widget may include any content type, such as audio, video, and/or text information asset, for example. Such a widget may be created through a widget studio engine. The widget studio engine, illustrated in FIG. 6, may allow for metrics and controls to be added to an existing or newly created widget. Added metrics may include macro tracking of, for example, widget use, distribution, modification or deletion. Micro metric tracking may include, for example, the time of widget use, whether audio was heard, whether the widget was fully displayed or otherwise limited in view, or if the widget was interrupted before completing the desired function.

By way of non-limiting example, a widget that includes video may be tracked as to its distribution and the number of video plays by the widget user. Further metrics may track whether the video was paused and/or rewound and at what points. Such tracking may provide the owner of the widget content with cumulative metrics such as total impressions, number of unique users, interaction level and number of domains, for example.

Further, these metrics may be used to determine “hot spots” in use and widget interest. These groupings of actions, such as downloads and use, may be correlated by geography, demographics, distribution point, and/or usage. For example, a “hot spot” may be created if a statistically high number of downloads of a particular widget are downloaded/accessed in a particular geographical area. Or, by way of further example, a statistically high number of users of a particular social networking site may make use of the widget in a pre-defined temporal window. Identified “hot spots” may allow a widget content owner to refine the widget asset, create and/or distribute more targeted widgets, for example.

The widget studio engine may also provide the widget creator with base platform design choices, such as the type of code used, acceptable platform compatibilities, and base media content, for example. For example, the widget studio engine may allow for the design of a widget which utilizes a flash player for the display of a video asset which is compatible for placement and use within a social networking site. Similarly, the same widget may be designed to be further compatible with a mobile device and, more specifically, a specific manufacturer's mobile device, for example.

In an embodiment of the present invention, a widget may be created with at least one function module, at least one asset, and at least one tracking metric. The at least one function module may include a asset player and/.or viewer, platform code sufficient to support a widget, compatibility functionality code and/or delivery functionality. The at least one asset may include a movie clip, static text and/or picture presentation, audio, and/or an interactive GUI, for example. The at least one tracking metric may include at least one user access measurement and/or a path/geography locator, for example.

In an embodiment of the present invention, a widget may function as a webtop. Such a widget webtop may work in conjunction with an existing webtop provided by an operating system and/or may be provided as a stand alone interface. Such a widget may allow for a customized webtop to be portably moved from and between multiple environments. The widget may be transferred by a user of the widget to a different device, for example, or may be stored away on the same device for use by an authorized user of the widget. By way of non-limiting example only, a user may wish to move a customized webtop widget from a PC to a television. Similarly, a customized webtop widget may allow a user to hide access to their specific widget and/or allow access to certain authorized users.

As mentioned above, a portable webtop widget may include simple code to allow for user preferences to be moved between devices or may include sufficient code to allow for a temporary user interface to be made available in a foreign environment. For example, a user may move a webtop widget to a PDA type device and continue to enjoy the customized features of the widget, such as color and stylizing features. A webtop widget may also provide a user with access links or content encryption keys, for example, which may allow at least for a virtual webtop within a device that is not the device where the widget was created or modified or last resident.

It will be apparent to those skilled in the art, in light of the disclosure herein, that traditional web-based advertising models may likewise be incorporated for use with the present invention.

Although the invention has been described and pictured in an exemplary form with a certain degree of particularity, it is understood that the present disclosure of the exemplary form has been made by way of example, and that numerous changes in the details of construction and combination and arrangement of parts and steps may be made without departing from the spirit and scope of the invention.

What is claimed is:

1. A widget, comprising:
at least one function module;
at least one asset; and
at least one tracking metric module;
wherein the at least one function module provides for display of the at least one asset in a user selected environment, and wherein said at least one module tracks at least one metric associated with the display.

2. The widget of claim 1, wherein the at least one function module includes a compatibility engine that provides code to operate the at least one function module based on the user environment.

3. The widget of claim 2, wherein the compatibility engine accesses code local to the function module.

4. The widget of claim 2, wherein the compatibility engine accesses code remote from the function module.

5. The widget of claim 1, wherein the at least one asset includes one selected from the group consisting of a movie clip, text, picture, audio, and interactive GUI.

6. The widget of claim 1, wherein the at least one asset includes at least one advertisement.

7. The widget of claim 6, wherein the at least one advertisement is limited to at least one group of advertisements selected in advance for use.

8. The widget of claim 1, wherein the at least one tracking metric records the location of the widget.

9. The widget of claim 1, wherein the at least one tracking metric records access to the at least one asset.

10. The widget of claim 1, wherein the at least one function module includes a portable avatar.

11. The widget of claim 1, wherein the at least one asset is selected from the group consisting of avatar attributes, user name, and user preferences.
